(19) United States
(12) Patent Application Publication
(10) Pub. No.: US 2010/0242289 A1
(43) Pub. Date: Sep. 30, 2010

(54) SCISSORS UTILIZING A FLEXIBLE AND DETACHABLE THUMB RING CONNECTION

(76) Inventors: Scott Roskam, Bigfork, MT (US); Dennis Soucie, Bigfork, MT (US)

Correspondence Address: Scott Roskam, 21649 Montana Highway 35, Bigfork, MT, 59911, US

(21) Appl. No.: 12/729,474

(22) Filed: Mar. 23, 2010

Related U.S. Application Data
(60) Provisional application No. 61/211,361, filed on Mar. 30, 2009.

(51) Int. Cl. B26B 13/00; B25G 1/00

(52) U.S. Cl. 30/232; 30/254; 30/341

(57) ABSTRACT

A scissors, useful particularly to hairdressers, comprising a finger grip handle (42) and a thumb grip handle (12) with a flexible and detachable thumb ring connection. A thumb ring (14) is flexibly coupled to thumb grip handle (12) such that universal articulated movement of thumb ring (14) is enabled to facilitate an improved range of natural thumb movement and an improved variable positioning of the scissors in the user's hand. Thumb ring (14) may alternatively be coupled to thumb grip handle (12) with a secure and stable connection to facilitate optimum control and accurate guidance of the scissors. A user may easily detach and reattach thumb ring (14) in either a flexible coupled position (28) or a secure coupled position (38) while actively cutting hair and without resort to use of tools or special manipulations. A user may continuously and easily detach and reattach thumb ring (14), while the scissors are in normal operative use, thus performing the new and desirable object of more easily freeing the user's thumb to grip a comb or other appliance even while it remains inserted in thumb ring (14).

This patent application is corresponding to Provisional Application U.S. 61/211,361 Filed Mar. 30, 2009 in accordance with 35 U.S.C. 119(e)

### BACKGROUND

1. Field of Invention

This invention relates to scissors, specifically to an improved universally rotatable thumb grip mechanism particularly useful to hair dressers and others who use scissors in concert with other hand held tools.

2. Description of Prior Art

Scissors incorporating a pivotal or rotationally articulate thumb grip loop or thumb ring have long been known, especially in the field of hair dressing shears. Such scissors have significant advantages over a scissors made with the thumb ring integrally formed with the thumb grip handle or a conventional scissors. Conventional scissors have two significant disadvantages:

(a) When opening and closing the conventional scissors, a user's thumb is stressed as a result of its movement within the thumb ring due to a sliding friction between it and the thumb ring of the scissors.

(b) Conventional shears cannot be used in a varied variety of positions, relative to the user's body, with out placing significant and fatiguing stresses on the joints, and muscles of the user.

The pivotal or rotational thumb ring or articulate thumb ring scissors mitigate these two above mentioned adverse effects of using conventional scissors. They allow a reduction of friction between the user's thumb and the scissors. The articulate thumb ring scissors also allow the user to cut with the scissors in a greater variety of positions with greater ease and with less bodily contortions. There are many inventions in the art of scissors aimed at overcoming the two above mentioned adverse effects.

For example, patents have been issued on improvements to scissors which allow the thumb ring to pivot in its connection to the thumb grip handle from a single axis (Cite Group A): U.S. Pat. No. 242,000 granted May 24, 1881 to J. Klaucke, U.S. Pat. No. 430,677 granted Jun. 24, 1890 to R. S. Pearsall, U.S. Pat. No. 440,436 granted Nov. 11, 1890 to R. S. Pearsall, U.S. Pat. No. 1,108,572 granted Aug. 25, 1914 to W. M. Gordon, and U.S. Pat. No. 5,109,608 granted May 5, 1992 to Pracht.

Patents have been also been issued on improvements to scissors which allow the thumb ring to rotate about a single axis in its connection to the thumb grip handle; for example (Cite Group B): U.S. Pat. No. 2,640,264 granted Jun. 2, 1950 to C. J. Sullivan et al, U.S. Pat. No. 3,906,630 granted Sep. 23, 1975 to Megna, U.S. Pat. No. 5,781,999 granted Jul. 21, 1998 to Chang, U.S. Pat. No. 5,987,757 granted Nov. 23, 1999 to Schmidt et al, U.S. Pat. No. 6,249,977 B1 granted Jun. 26, 2001 to Knoop, and U.S. Pat. No. 5,659,959 granted Aug. 26, 1997 to Parlowski. The above mentioned examples offer only limited articulation of the thumb ring relative to the thumb grip handle and only articulate around a single axis.

In the prior art single axis articulate thumb ring scissors, the user is provided with only limited possibilities of variable positioning of the scissors. The limited articulate motion of the scissors does not fully accommodate the natural unrestricted motion of a user's thumb. So the need for more comfortable and more easily manipulated scissors is still a strongly felt need. For that reason, further improvements were offered that combined both the pivoting and rotational articulation of the thumb ring about multiple axes. Examples of multi axes rotatable articulate thumb ring or universally articulate thumb ring scissors are found in patents issued to (Cite Group C): U.S. Pat. No. 3,906,630 granted Sep. 23, 1975 to Megna, U.S. Pat. No. 4,642,895 granted Feb. 17, 1987 to Gauvry, and U.S. Pat. No. 4,742,617 granted May 10, 1988 to Gaurvy.

The universally articulate thumb ring scissors have effected further improvements by creating more easily position able scissors which are also more comfortable to use. Even so, all the articulate thumb ring scissors developed particularly for hairdressers have significant disadvantages when compared to conventional scissors. Users find it difficult to control and accurately guide the articulate thumb ring scissors in all cutting situations. It is the thumb grip handle which guides the moving scissors blade. The inability of universally articulate thumb ring scissors to be accurately controlled is largely due to the lack of stability of the universally articulate thumb ring connection to the thumb grip handle; this is an inherent control problem.

The above described control problem is more severe with the universally articulate thumb ring shears because the articulating joint is generally less stable than that of the single axis articulating thumb ring scissors. Many attempts were made to resolve the control problem as evidenced by devices to both limit and even snub all articulate movement of the thumb ring. Examples of such devices and the specific discussions pertaining to the need for such devices, (referenced by page and beginning line number in the applicable prior art patents) are found in (Cite Group D): U.S. Pat. No. 3,906,630 granted Sep. 23, 1975 to Megna on page 2 line 19; U.S. U.S. Pat. No. 6,249,977 B1 granted Jun. 26, 2001 to Knoop on page 2 line 34; U.S. Pat. No. 4,642,895 granted Feb. 17, 1987 to Gauvry on page 2 line 21, U.S. Pat. No. 4,742,617 granted May 10, 1988 to Gaurvy on page 2 line 21 and U.S. Pat. No. 5,109,608 granted May 5, 1992 to Pracht on page 2 line 54.

The prior art attempts to mitigate the control problem all necessitated devices for decreasing, limiting or even eliminating articulation of the thumb ring. The use of these devices consequently lessened or eliminated the functionality of the very structures that accomplished the desirable objects of their inventions. The limiting devices specifically have the undesirable effect of lessening the extent to which the scissors can be manipulated into different positions in the user's hand. The limiting devices also lessen the extent to which the scissors can be variably positioned in relationship to the user's body. The limiting devices are not easy or practical to use while actively cutting hair. Tools or two handed manipulations are needed in order to apply or to disengage or to otherwise adjust the limiting devices taught in the prior art. The prior art universally articulate thumb ring scissors provide improved comfort and positioning but at the cost of control. If a user wants accurate control commensurate with that of the conventional scissors, the prior art teaches that he must sacrifice, at least to some extent, the comfort and positioning advantages afforded by the articulate thumb ring scissors.

In addition to the control problem, users also had a second significant problem in using the prior art articulate thumb ring scissors. They could not use a comb or other tool in concert with the improved scissors as easily as they could with the conventional scissors; this is an inherent use in concert problem.

It is common practice with hair dressers and with crafts people, such as those who hand tie fly lures used for fishing, to continuously switch between the use of a scissors and another hand held tool such as a comb. They use them together in concert. For hairdressers, it is necessary that a scissors and a comb are manipulated and largely controlled by the same hand. It is common for a user to remove the thumb from the thumb ring of a scissors, re-grip the scissors in the palm of that same hand, transfer the comb from the other hand into the hand which is also holding the scissors, comb a section of hair to prepare it for cutting, transfer the comb back to the original hand that held it, replace his thumb into the thumb ring in order to regain control of the scissors and then cut that prepared section of hair. This technique is commonly known in the art of haircutting as “palming the scissors”. It is a common practice done repetitively during the act of cutting hair.

The use in concert problem, referred to above, is principally caused by the difficulty the user has in quickly removing his thumb from, and then subsequently reinserting his thumb into, the articulate thumb ring. In order to reinsert the thumb, the user must often purposefully manipulate the articulate thumb ring in order to reposition it. This is an unwanted distraction which interrupts the act of cutting hair.

It is especially difficult to quickly and easily remove the thumb from the universally articulate thumb ring scissors if the thumb ring fits even a little too tightly. The universally articulate thumb ring tends to move with the thumb. So, instead of allowing the easy release of the user's thumb, the thumb tends to wedge against the sides of the ring more tightly. This is because the ring tends to tilt toward and against the top of the thumb more than it does against the pad of the thumb which is closer to the location of the thumb ring's point of articulated attachment to the thumb grip handle. So, the thumb of the user tends to become locked in place in the thumb ring and a greater force is necessary to remove it than the force necessary to remove it from a similarly sized ring on a conventional scissors. Yet, if the thumb ring fits too loosely, the thumb of the user tends to inadvertently slip out of the thumb ring when the shear is in use. This is because the universally articulate thumb ring is free to move in any direction unless the user is actively pressing his thumb on some surface of the thumb ring. The above mentioned problems with the gripping of a universally articulate thumb ring scissors renders them particularly unsuitable for use in concert with other tools.

The gripping problems described above were specifically addressed, by improvements described in four patents all issued to Brenton et al. (Cite Group E): U.S. Pat. No. 5,125,159 granted Jun. 30, 1992, U.S. Pat. No. 5,301,430 granted Apr. 12, 1994, U.S. Pat. No. 5,469,624 granted Nov. 28, 1995, and U.S. Pat. No. 7,424,778 B2 granted Sep. 16, 2008. Brenton's preferred embodiments largely combined the universally articulate thumb ring scissors features, as described in U.S. Pat. No. 4,742,617 granted May 10, 1988 to Gauvry, with various detachable thumb ring components. These improvements enabled a user to change the thumb ring size and shape with the use of tools and special adjustments. These improvements offered some palliation for “the use in concert problem” referred to above. However, Brenton does not offer any solution to “the control problem”, mentioned earlier, and still inherent in all prior art articulate thumb ring scissors.

The use of a scissors and a comb in concert, in the art of hair cutting, requires the development of special skill and dexterity to perform well. Thus, devices and methods which facilitate the ease of using scissors together with combs are advantageous and very desirable. The need for tools which enable greater ease in performing the technique of using a comb in concert with a scissors or “palming the shears” have long been felt. Many patents have been issued on a variety of inventions whose objects are, at least in part, described as improvements over the techniques normally employed by using conventional scissors in concert with other hand held tools.

Hair cutting implements have been combined with combs in a single tool such as those found in patents issued to (Cite Group F): U.S. Pat. No. 2,008,631 granted Jul. 16, 1935 to M. Udkovich, U.S. Pat. No. 2,677,179 granted May 4, 1954 to W. J. Servillia, U.S. Pat. No. 3,972,337 granted Aug. 3, 1976 to Pomaro, U.S. Pat. No. 2,640,264 granted Jun. 2, 1950 to C J. Sullivan et al., U.S. Pat. No. 5,012,830 granted May 7, 1991 to Vaccaro et al., U.S. Pat. No. 5,259,114 granted Nov. 9, 1993 to Shorter, and U.S. Pat. No. 6,526,663 B1 granted Mar. 4, 2003 to Simmons et al. These improvements are useful in eliminating the need to manipulate two separate tools simultaneously. However, they are severely disadvantageous as they are cumbersome compared to conventional scissors and are impractical to use in all aspects of cutting hair, especially in areas where clearances for cutting with a scissors are small.

Other improvements in functionality of scissors for performing a use in concert with other tools are focused on unique and non annular shapes for the thumb ring. Substantially U or C shaped thumb grips or a thumb open loop are extensively described as improvements in the specific function of thumb removal out of, and reinsertion into, the thumb grip or loop of a scissors. Improvements and discussions that are especially pertinent to use in concert techniques are found in patents issued to (Cite Group G): U.S. Pat. No. 5,060,381 granted Oct. 29, 1991 to Taberlet on page 3 line 8, U.S. Pat. No. 5,781,999 granted Jul. 21, 1998 to Chang on page 1, line 17, U.S. Pat. No. 6,249,977 B1 granted Jun. 26, 2001 to Knoop on page 2 line 66, U.S. Pat. No. 6,457,241 B1 granted Oct. 1, 2002 to Droin on page 1 line 15 and U.S. Pat. No. 6,883,238 B1 granted Apr. 26, 2005 to Tran on page 1 line 40.

These improvements do aid the functionality of scissors as they are used in concert with other tools. However, they have severe disadvantages over conventional scissors. The open thumb loops lack the ability to maintain a firm and secure contact between the thumb of the user and the open thumb loop. So, the thumb of the user can easily and unintentionally be disengaged with the thumb controlled handle of the scissors. Also the open thumb loop scissors cannot be accurately guided nor controlled in many common cutting situations and positions. These disadvantages are acknowledged in the prior art; for example: U.S. Pat. No. 6,249,977 B1 granted Jun. 26, 2001 to Knoop on page 2 line 66. Knoop offers a palliation to the drawbacks of his “rotating grip . . . c-shaped design” by providing for the detachment of the thumb open loop and replacement thereof with a more conventional closed annular ring. Quote: “ . . . if great importance is attached to particularly effective guidance of the rotating grip.” Knoop further provides for the fixing of the annular ring in a secure and unmovable connection to the thumb grip handle thereby converting his scissor into an effectively conventional scissors. However the conversion of Koop's scissors involves the necessary use of tools and two handed manipulations that cannot be preformed while the user is in the normal act of cutting hair.

It is widely taught, in the prior art, that thumb rings may be made adjustable in their position along a longitudinal axis of the thumb ring to facilitate a improved accommodation for differences in hand sizes and a improved suitability to a wide range of user's personnel preferences. It is also widely taught to make thumb rings detachable from the thumb grip handle to facilitate interchange of thumb rings of different sizes and shapes. However, the prior art teaches that to make adjustments in the thumb ring position or change interchangeable thumb rings the user must use tools or perform special manipulations of the scissors. These manipulations are clearly impractical to perform repetitively or consistently while actively cutting hair. The prior art does not teach nor suggest that a thumb ring can be detached from, and reattached to a thumb grip handle to facilitate any improved method for actively cutting hair. Specifically, there is no teaching in the prior art that even suggests that a detachable connection for a thumb ring to a thumb grip handle could facilitate improved usefulness for scissors when used in concert with other hand held tools.

Indeed, neither in the prior art for scissors making nor in the prior art for hair cutting is there any teaching that even suggests that detachment and reattachment of the thumb ring of a scissors can be made while a user is in the act of cutting hair. Nor is it anywhere suggested that any benefit could derive from such a practice was it somehow made possible to do so.

### SUMMARY ON BACKGROUND OF PRIOR ART

The prior art pertinent to the subject of the present invention has taught the making of improved scissors with articulating thumb ring attaching structures that provide a greater ease and comfort in use by facilitating a more natural movement of a user's hand and a more variable range of scissors positioning.

However, the means employed to achieve these objects have also produced resultant undesirable and disadvantageous effects on the user's ability to accurately control the improved scissors. The prior art articulating thumb ring scissors have also failed to function as well as conventional scissors when used in concert with other hand held tools.

### OBJECTS AND ADVANTAGES

Accordingly several objects and advantages of my invention are:

(a) To provide a scissors with a thumb grip ring with a substantially unrestricted range of rotation extending to all axes of rotation possible within a universal 180 degree range from multiple points of attachment to a thumb grip handle. This facilitates an improved range of positioning within a user's hand and an improved range of variable positioning of the scissors relative to a user's body.

(b) To provide a scissors with an easily detachable and re-attachable thumb ring such that a user can consistently detach and reattach the thumb ring while the scissors are in normal use. This facilitates a new and improved method for the use of scissors in concert with other hand held tools.

(c) To provide a scissors whose thumb ring easily disengages from the thumb grip handle. This allows the user maintains his thumb inserted into the thumb ring to facilitate an improved method of grasping and using other hand held tools in concert with scissors.

(d) To provide a scissors that is easy for a user to regain control of and operate, after they have used another tool in that same hand which controls the scissors. This is accomplished by enabling the user's thumb to remain in the thumb ring and making the thumb ring easily re-attachable to the thumb grip handle.

(e) To provide a scissors whose detachable thumb ring is reengaged to the thumb grip handle quickly and easily with out the use of tools and without recourse to performing any two handed manipulations of the scissors that would interrupt a user from actively cutting hair or otherwise operating the scissors normally.

(f) To provide a scissors with an easily detachable and re-attachable thumb ring whereby the user can consistently detach and reattach the thumb ring without the use of tools or recourse or any special manipulations of the scissors which would require the use of two hands.

(g) To provide a scissors with an articulate thumb ring which is easily convertible from an articulated connection to a substantially integral and securely fixed connection to the thumb grip handle. This facilitates improved scissors control and guidance accuracy that is commensurate with that of a conventional scissors.

(h) To provide a scissors whose securely fixed thumb ring is easily convertible from a effectively integral connection to the thumb grip handle to a universally articulate connection. This facilitates an improved range of possible scissors positioning within a user's hand and an improved range of variable positioning of the scissors relative to the user's body.

(i) To provide a scissors with an articulating thumb ring attachment which is rotatable from variable points of attachment on a thumb grip handle to facilitate a improved range of adaptability to the natural motion of a user's thumb and hand in varying cutting situations and positions.

(j) To introduce a new method of cutting hair whereby hairstylists may use the improved scissors utilizing a flexible and detachable thumb ring connection in concert with other hand held tools with greater ease and convenience than what is possible with conventional scissors.

Still further objects and advantages will become apparent from a consideration of the ensuing description and drawings.

### DRAWING FIGURES

In the drawings, closely related figures have the same number but different alphabetic suffixes.

FIG. 1 shows the first embodiment with the secure fixing mount located forward.

FIG. 1A shows a view with the thumb ring in the flexible coupled position.

FIG. 1B shows a partial perspective view with the thumb ring in the flexible coupled position.

FIG. 1C shows a partial view with the thumb ring in the secure coupled position.

FIG. 1D shows a partial perspective view with the thumb ring in the secure coupled position.

FIG. 2 shows a perspective view of the second embodiment with the secure fixing mount disposed rearward.

FIG. 2A shows a view with the thumb ring in the flexible coupled position.

FIG. 2B shows a partial view with the thumb ring in the secure coupled position.

FIG. 3 shows a third embodiment with a mechanical connection employed to effect the secure coupled position of the thumb ring.

FIG. 4 shows a forth embodiment which best incorporates the features of the Freeform Magnetic Mechanism described in Provisional Application U.S. 61/211,361.

FIGS. 5 and 5A shows an alternative embodiment with non-magnetically attractive material included in the thumb ring structure.

FIG. 6 shows the scissors held in the palm with the thumb ring detached.

FIG. 7 shows the scissors being held (or “palmed”) while being used in concert with a comb.

FIG. 8 shows some of the possible articulate positions of the thumb ring in the flexible coupled position.

### DRAWINGS REFERENCE NUMERALS

10 moving blade
12 thumb grip handle
14 thumb ring
16 thumb ring groove
20 flexible fixing mount
22 disk magnet
22a sphere magnet
24 dampening disk
26 thumb ring magnet
28 flexible coupled position
30 secure fixing mount
32 rod magnet
32a cylinder magnet
38 secure coupled position
40 stationary blade
42 finger grip handle
44 scissors pivot

### DESCRIPTION OF THE INVENTION

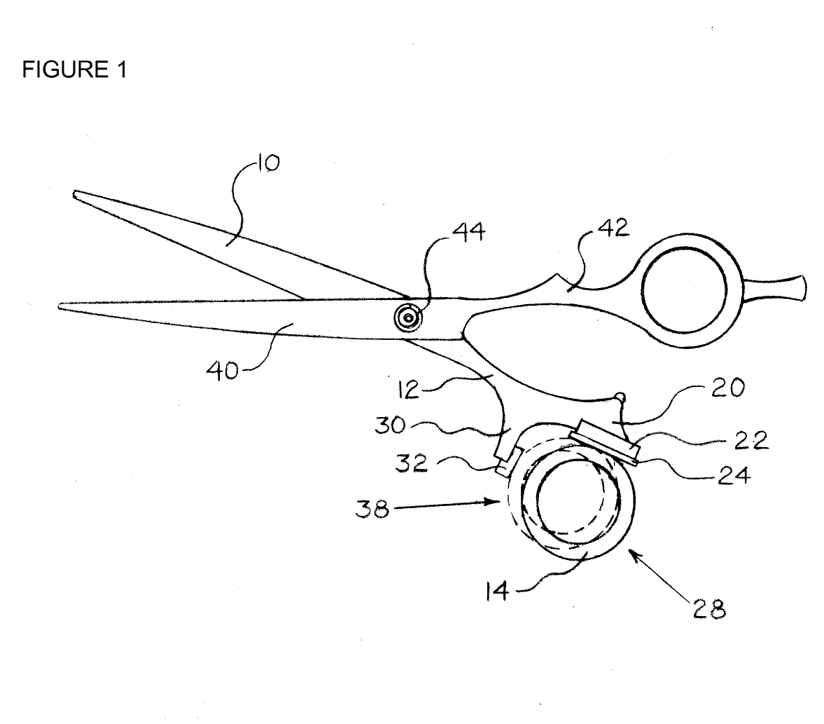

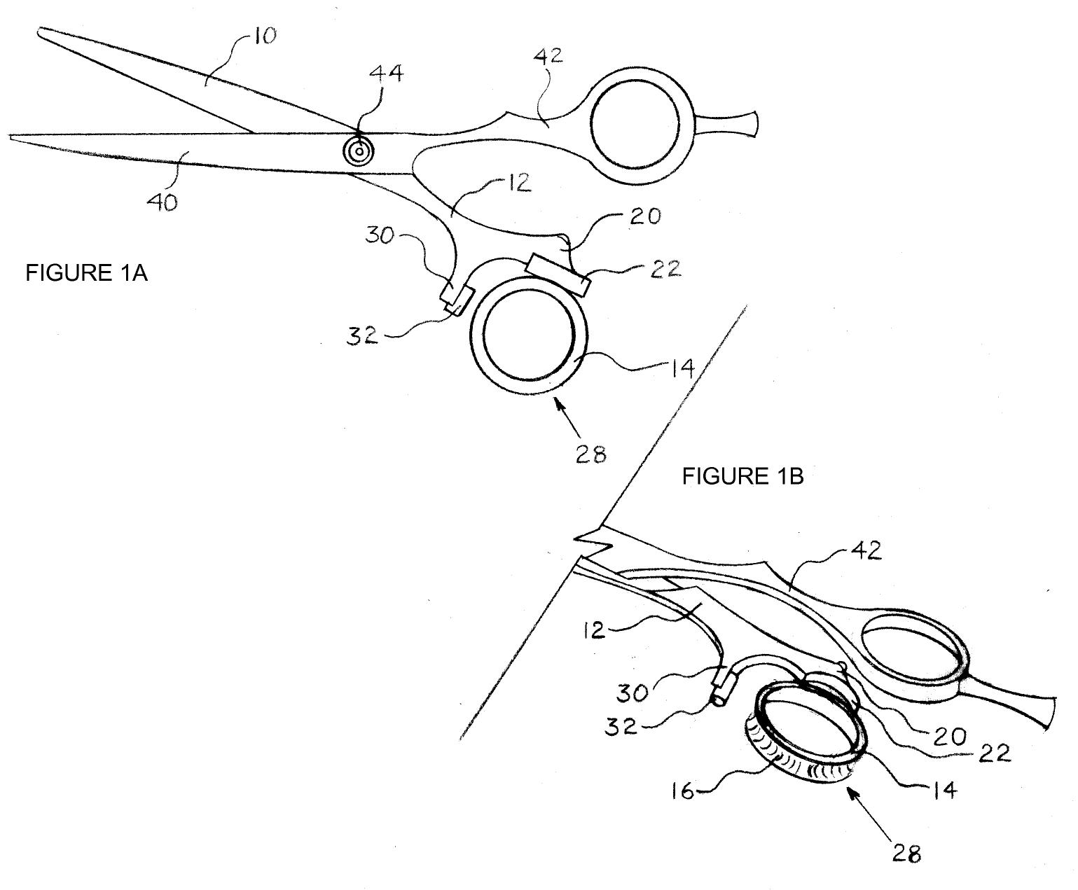

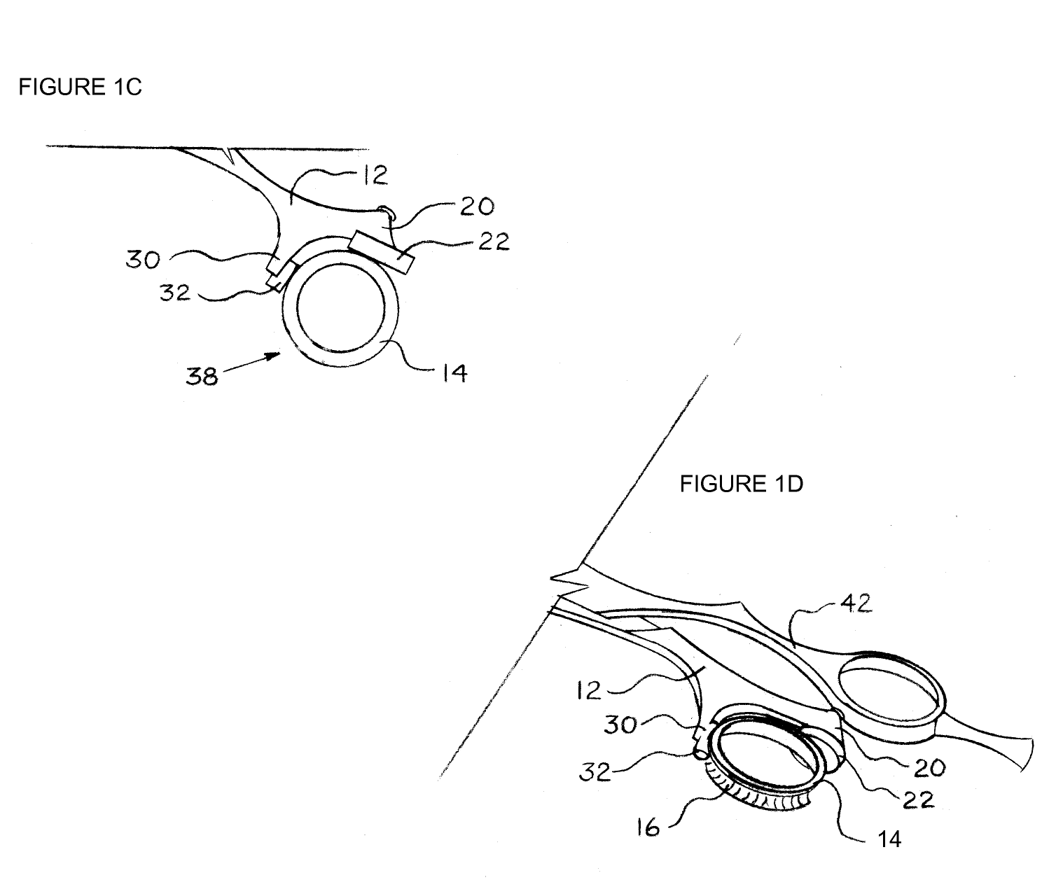

FIG. 1 shows a scissors which includes a moving blade 10 and a stationary blade 40. Moving blade 10 and stationary blade 40 are connected by a scissors pivot 44. Scissors pivot 44 can be formed by any method known in the art of scissors. A finger grip handle 42 is disposed on stationary blade 40. A thumb grip handle 12 is disposed on moving blade 10. A thumb ring 14 is detachably fixed to thumb grip handle 12.

In our preferred embodiment, a flexible fixing mount 20 is formed integral with thumb grip handle 12. Flexible fixing mount 20 includes a flat section which is approximately parallel with the longitudinal axis of moving blade 10 and also parallel with the pivotal axis of scissors pivot 44. A disk magnet 22 is permanently attached to the flat section of flexible fixing mount 20 using any suitable permanent metal bonding adhesive such as a two part epoxy adhesive made by J-B Weld Company (P.O. Box 483, Sulphur Springs, Tex. 75483). The disk magnet 22 is an axially magnetized type 42 neodymium disk shaped rare earth magnet measuring approximately 13 mm in diameter with a thickness of approximately 3 mm. Magnets of this type are available from K&J Magnetics, Inc (2110 Ashton Dr, Ste 1A, Jamison, Pa. 18929). Thumb ring 14 is made from magnetically attractive steel which is preferably stainless. Either 416 or 410 grade stainless steel is suitable for the purpose of forming thumb ring 14 in a preferably oval shape so as to fit well upon a thumb of a user.

As shown in FIG. 1A, thumb ring 14 is magnetically attracted to and flexibly coupled to the exposed surface of disk magnet 22 such that it may rotate universally about a multiplicity of axes passing through disk magnet 22.

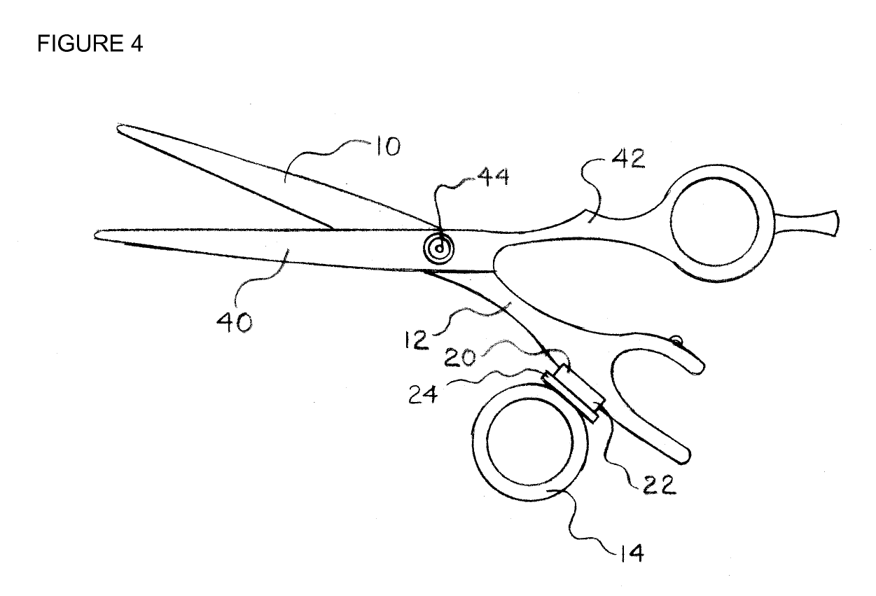

As is shown in FIG. 1 and in FIG. 4, dampening disk 24 may be interposed between disk magnet 22 and thumb ring 14 to facilitate a beneficial resistance or a dampening effect on the rotational movement of thumb ring 14. Dampening disk 24 further serves to cushion and quiet the coupling of thumb ring 14 to disk magnet 22. Even so, the incorporation of dampening disk 24 is not a necessary component to the basic functionality of our preferred embodiments.

Dampening disk 24 is made of a soft leather disk approximately 14 mm in diameter. Dampening disk 24 is attached to the exposed circular surface of disk magnet 22 with a semi-permanent adhesive. The use of a semi-permanent adhesive facilitates replacement of dampening disk 24 when it becomes worn through use. Dampening disk 24 may also be made from felt like materials, cork like materials, thin foam rubber like materials, vinyl and other plastics and the like. The provision of varied interchangeable dampening materials does allow a user to subtly alter the rotational characteristics and the detachable coupling characteristics of thumb ring 14 to best suit their individual preferences.

Thumb ring 14 may be detached from thumb grip handle 12 by the thumb of the user exerting sufficient force on thumb ring 14, in a rearward direction generally along the longitudinal axis of thumb grip handle 12, such that the magnetic connection of thumb ring 14 with disk magnet 22 is broken. The use of materials of varying thicknesses to form dampening disk 24 will alter the forces required to uncouple thumb ring 14 from disk magnet 22. Hard plastics may also be used to form dampening disc 24. Hard plastics can be molded or shaped with ridges and concavities such that thumb ring 14 may be more easily detached in certain favorable directions, such as in a direction along the longitudinal axis of thumb grip handle 12.

FIG. 1B shows a perspective view of a secure fixing mount 30 formed on thumb grip handle 12 forward of flexible fixing mount 20. A rod magnet 32 is permanently fixed in a concave circular groove which is formed on a lower surface of secure fixing mount 30. Rod magnet 32 is a diametrically magnetized neodymium type 42 rare earth magnet which is rod shaped with dimensions of approximately 3 mm diameter and 6 mm thickness.

FIG. 1D best shows a thumb ring circular groove 16 formed into the outside circumference of at least that part of thumb ring 14 which can be made to face towards secure fixing mount 30. Thumb ring circular groove 16 is formed on thumb ring 14 with a 0.75 mm radius so as to correspond and couple with rod magnet 32.

FIGS. 1C and 1D show two different partial views of thumb ring 14 slid forwards off from a centered position on disk magnet 22 so as to magnetically couple thumb ring 14 to rod magnet 32 even as thumb ring 14 remains coupled to disk magnet 22. When thumb ring 14 is slid or otherwise positioned forwards of a centered position on disk magnet 22 and coupled magnetically with rod magnet 32, it is securely fixed by two points of connection. The two points of connection of thumb ring 14 are spaced approximately 90 degrees apart with respect to the circumference of thumb ring 14, thereby effectively fixing thumb ring 14 substantially inarticulate with respect to thumb grip handle 12 in a secure coupled position 38.

Thumb ring 14 may be detached from secure coupled position 38 by the thumb of the user exerting sufficient rearward directed force on thumb ring 14 to break its magnetic connection with rod magnet 32. Thumb ring 14 will then be in a flexible coupled position 28 as shown in FIGS. 1A and 1B. When thumb ring 14 is in flexible coupled position 28, it is flexibly coupled to disk magnet 22 such that it may rotate universally about a multiplicity of axes passing through disk magnet 22. FIG. 8 shows thumb ring 14 in various rotated and pivoted operational positions in relation to thumb grip handle 12.

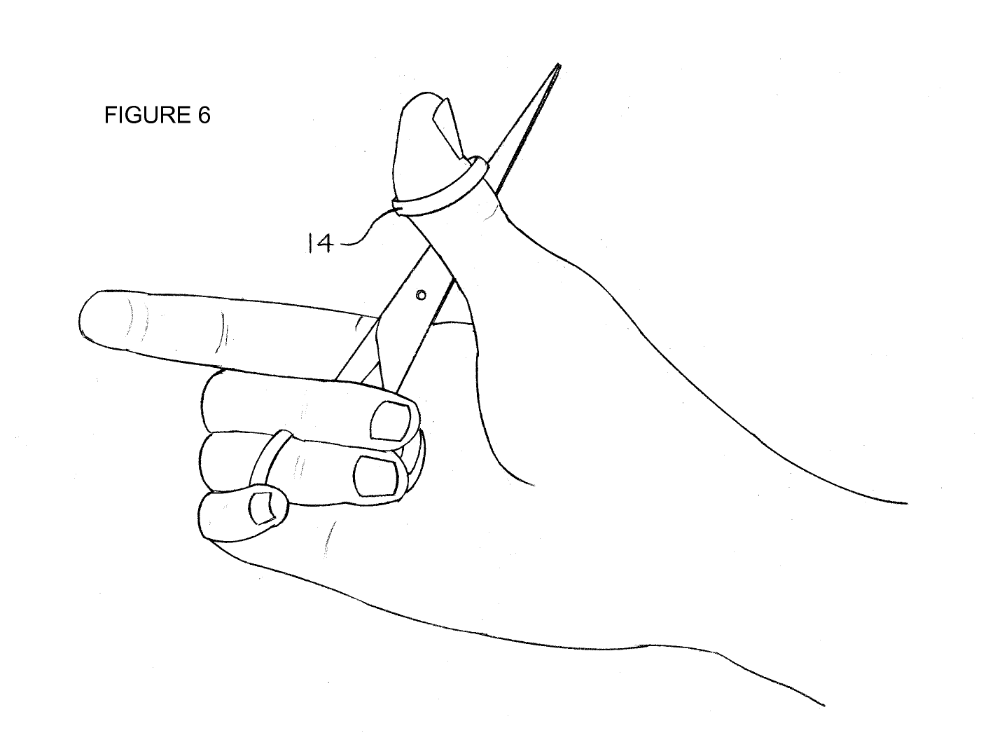

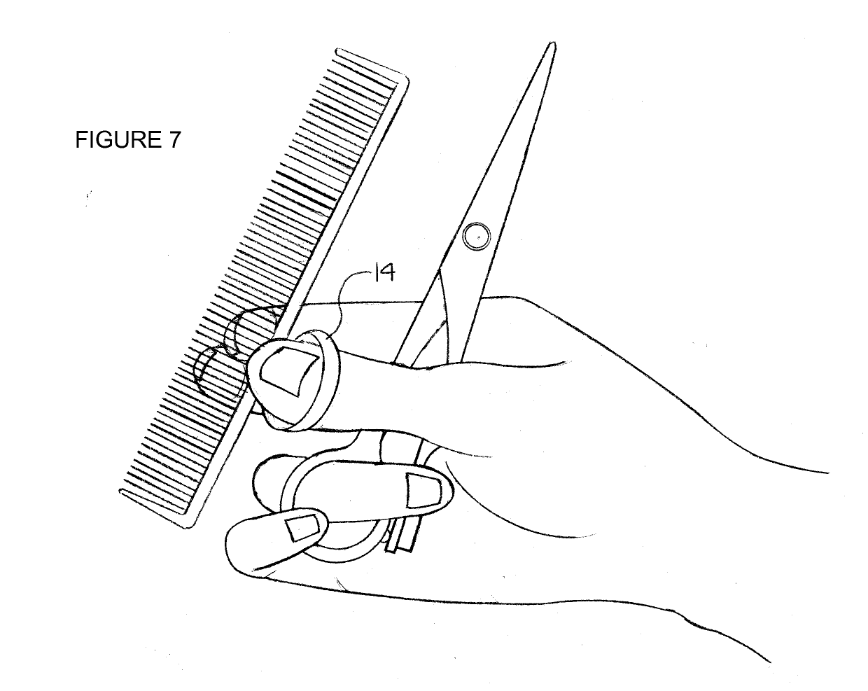

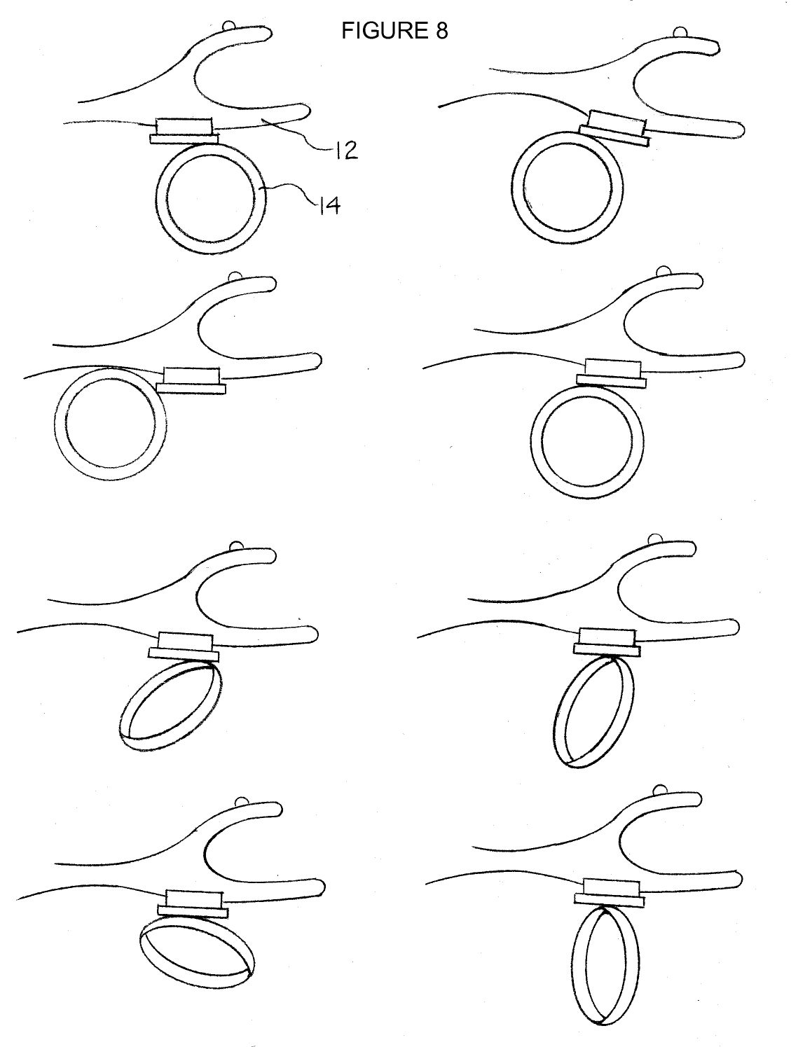

Thumb ring 14 may be entirely detached from both rod magnet 32 and disk magnet 22 by a further rearward application of force on thumb ring 14. Thumb ring 14 will remain on the thumb of the user as shown in FIG. 6. The thumb and some fingers of the user are free to grasp another tool such as a comb, as shown in FIG. 7, even while the user holds the scissors secure in his palm or “palms the scissors”. Thumb ring 14 may subsequently be reattached to disk magnet 22 in flexible coupled position 28 by the user bringing thumb ring 14 into close proximity with disk magnet 22.

Thumb ring 14 may alternatively be reattached to disk magnet 22 and rod magnet 32 in secure coupled position 38. In secure coupled position 38, the scissors will operate with characteristics that are similar to those of a conventional scissors whose thumb ring is formed integral with its scissors handle.

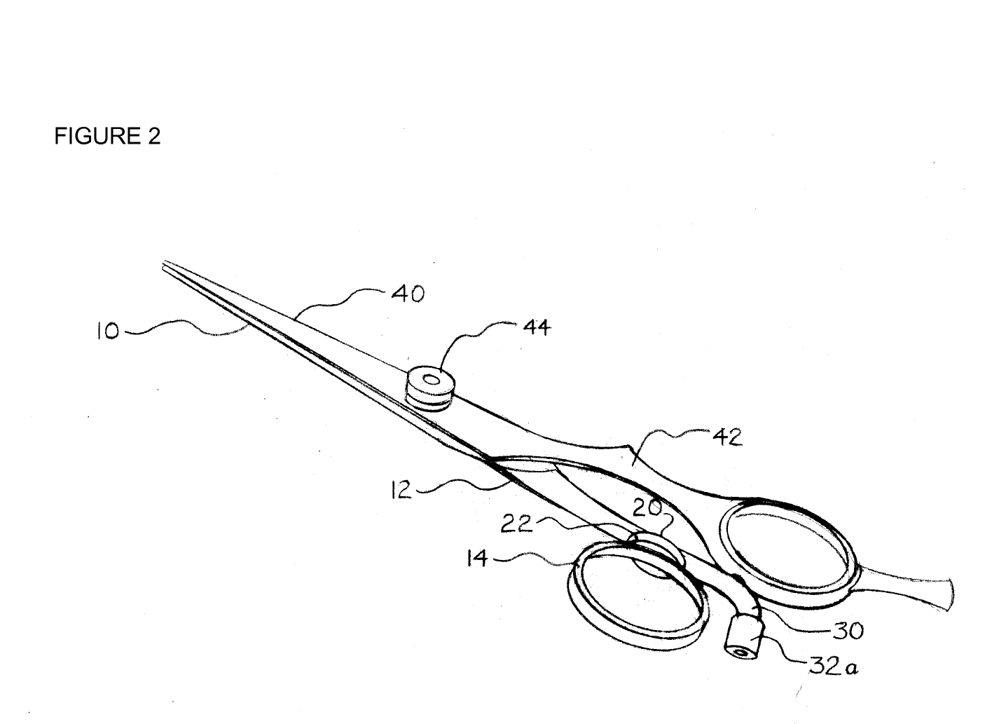

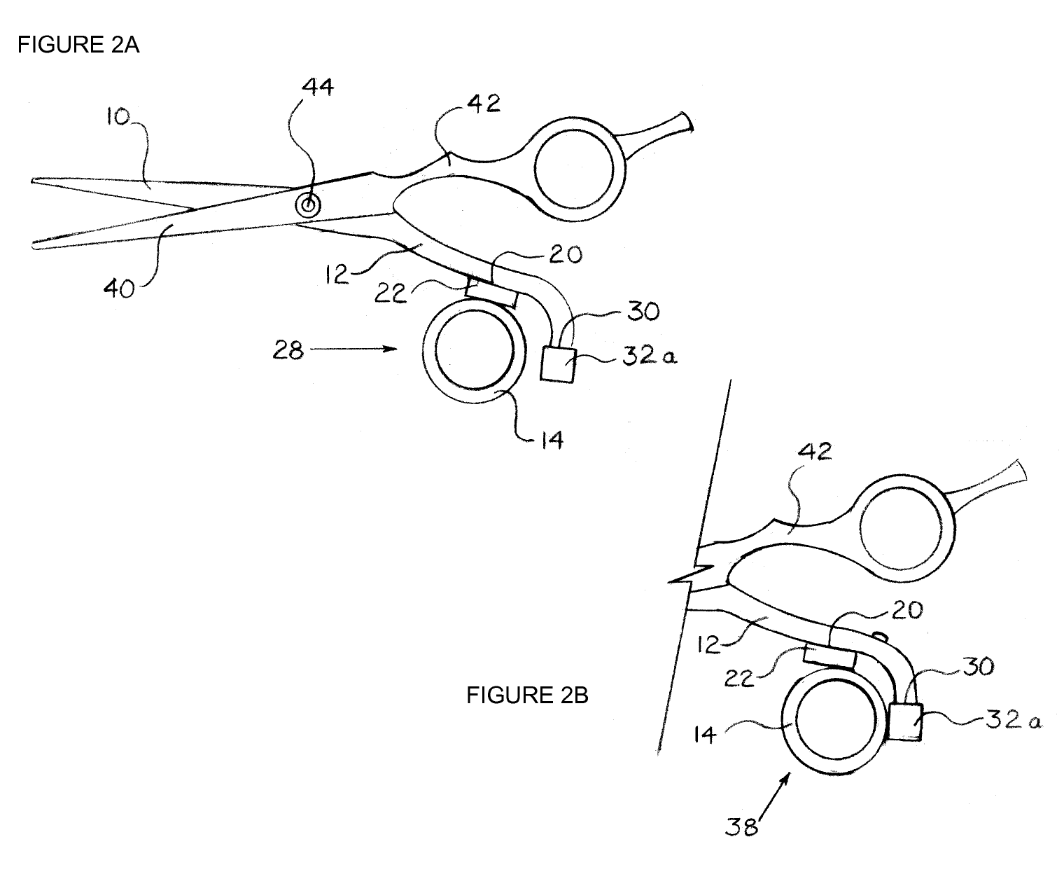

In our preferred embodiment secure fixing mount 30 is formed on thumb grip handle 12 forward of flexible fixing mount 20. However, in a second embodiment, shown in FIG. 2, secure fixing mount 30 is formed on thumb grip handle 12 in a location rearward of flexible fixing mount 20. In this second embodiment, secure fixing mount 30 is formed integral with thumb grip handle 12. Secure fixing mount 30 includes a round pin which is oriented with its longitudinal axis transverse to the longitudinal axis of thumb grip handle 12 and also oriented perpendicular to the pivotal axis of scissors pivot 44. A cylinder magnet 32a is fixed around the round pin of secure fixing mount 30 with a permanent metal bonding adhesive. Cylinder magnet 32a is a diametrically magnetized type 42 neodymium rare earth magnet which is cylindrically shaped and measures approximately 6 mm OD, 2 mm ID with a thickness of approximately 6 mm. Magnets of this type are available from KJ Magnets.

FIG. 2B shows thumb ring 14 slid rearward off from a centered position on disk magnet 22 so as to magnetically couple thumb ring 14 to cylinder magnet 32a even as it remains coupled to disk magnet 22. When thumb ring 14 is slid or otherwise positioned rearwards of a centered position on disk magnet 22 and coupled magnetically with cylinder magnet 32a, it is securely fixed by two points of connection. The two points of connection of thumb ring 14 are spaced approximately 90 degrees apart with respect to the circumference of thumb ring 14. The two points of connection present in secure coupled position 38 effectively fix thumb ring 14 substantially inarticulate with respect to thumb grip handle 12.

Thumb ring 14 may be detached from secure coupled position 38 by the thumb of the user exerting sufficient forward directed force on thumb ring 14 to break its magnetic connection with cylinder magnet 32a. Thumb ring 14 will then be in flexible coupled position 28, as shown in FIG. 2A, such that it may rotate universally about a multiplicity of axes passing through disk magnet 22. Thumb ring 14 may be entirely detached from both cylinder magnet 32a and disk magnet 22 by a similar application of sufficient forward directed force on thumb ring 14. The further operations and features of this second embodiment are similar to those described above pertaining to the first embodiment.

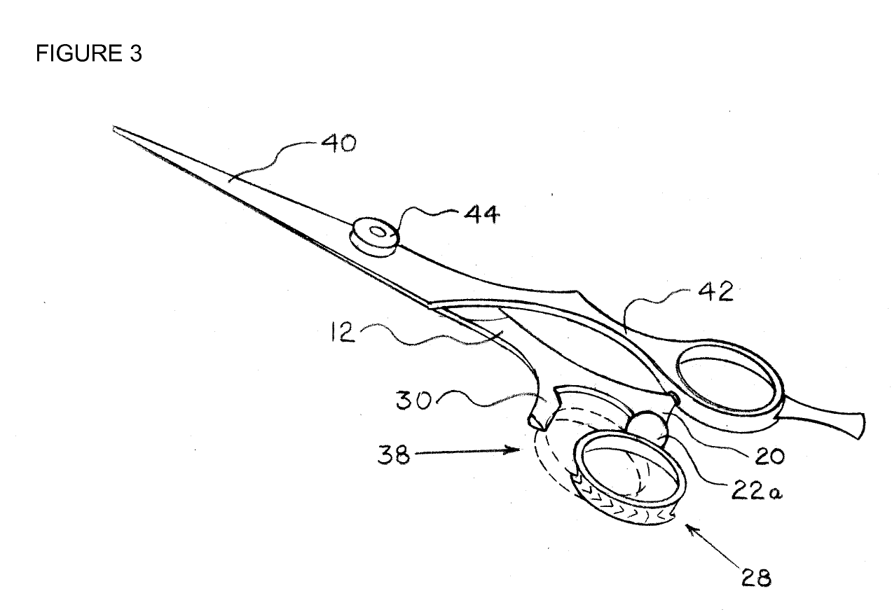

A third embodiment is shown in FIG. 3. In this third embodiment, secure fixing mount 30 is formed so as to mechanically connect or couple with thumb ring 14. In the first and second embodiments, described above, magnetic coupling is utilized to couple thumb ring 14 to secure fixing mount 30 and flexible fixing mount 20. This third embodiment utilizes magnetic coupling only within the structure of flexible fixing mount 20. FIG. 3 shows flexible fixing mount 20 with a concave spherically shaped depression formed on its lower surface into which a sphere magnet 22a is fixed. Sphere magnet 22a is an axially magnetized neodymium type 42 spherically shaped rare earth magnet measuring approximately 13 mm in diameter. Sphere magnet 22a is permanently glued into flexible fixing mount 20. When thumb ring 14 is magnetically coupled to sphere magnet 22a it is free to articulate. Thumb ring 14 is also free to slide upon the outside surface of sphere magnet 22a in a forward direction toward secure fixing mount 30. Secure fixing mount 30 is formed on thumb grip handle 12 forward of flexible fixing mount 20. A wedge shape is formed integral on the terminus of secure fixing mount 30. A apex of the wedge shaped portion of secure fixing mount 30 is oriented to point towards flexible fixing mount 20. In this third embodiment, thumb ring 14 has a syncline groove formed around its outside circumference such that it will cooperate with the apex of the wedge shaped portion of secure fixing mount 30.

When thumb ring 14 is moved forwards, it slides around the circumference of sphere magnet 22a as it remains magnetically connected. Thumb ring 14 also moves up towards thumb grip handle 12 as it is slid forward. FIG. 3 shows thumb ring 14 in secure coupled position 38 as it is connected with sphere magnet 22a and connected with secure fixing mount 30 such that it is secured in a relatively unmovable and inflexible position with respect to thumb grip handle 12. Thumb ring 14 may be detached from secure fixing mount 30 by exerting sufficient force in a downward and rearward direction on thumb ring 14 to dislodge it from secure fixing mount 30. The further operations and features of this third embodiment are similar to those described above pertaining to the first and second embodiments.

A fourth embodiment is shown in FIG. 4. This fourth embodiment is most similar to that scissors described in Provisional Application 61/211,361 and therein titled: Freeform Magnetic Mechanism. The fourth embodiment has structure very to the first preferred embodiment, shown in FIG. 1 and described above, but it does not incorporate the features and functions enabled by secure fixing mount 30. This fourth embodiment does not have the ability to fix thumb ring 14 in a secure coupled position in relation to thumb grip handle 12. Thumb ring 14 is only coupled a flexible position. All of the improved flexible universally rotatable thumb ring features and functions described for the previous three embodiments are present in this fourth embodiment. This fourth embodiment also incorporates a U shaped thumb loop which is disposed on the terminus of thumb grip handle 12. A user may place their thumb in the thumb loop to operate the scissors whenever especially accurate scissors control and guidance is desired.

In other alternative embodiments the flexible fixing mount components and the secure fixing mount components could also be chosen from the group comprising: semi permanent adhesive resins and other polymers, compounds with impermanent adhesive properties, Velcro@ or like materials, materials with magnetic properties and the like.

In our above described preferred embodiments, thumb ring 14 is formed of material that is attractive to material used in flexible fixing mount 20. This allows thumb ring 14 to have a flexible and easily severable connection with flexible fixing mount 20. In the first four embodiments the thumb ring is formed from martinsitic stainless steel in an oval shape so as to fit comfortably around the thumb of an average user. However in other embodiments the thumb ring may be shaped in a loop or other shape and may be comprised partially of material which is not attractive to any material used in flexible fixing mount 20. Such alternative materials for use in forming thumb ring 14 could be chosen from the group including non ferrous metals such as aluminum, precious metals such as gold or silver, leather, materials such as Velcro@ or plastic materials and the like.

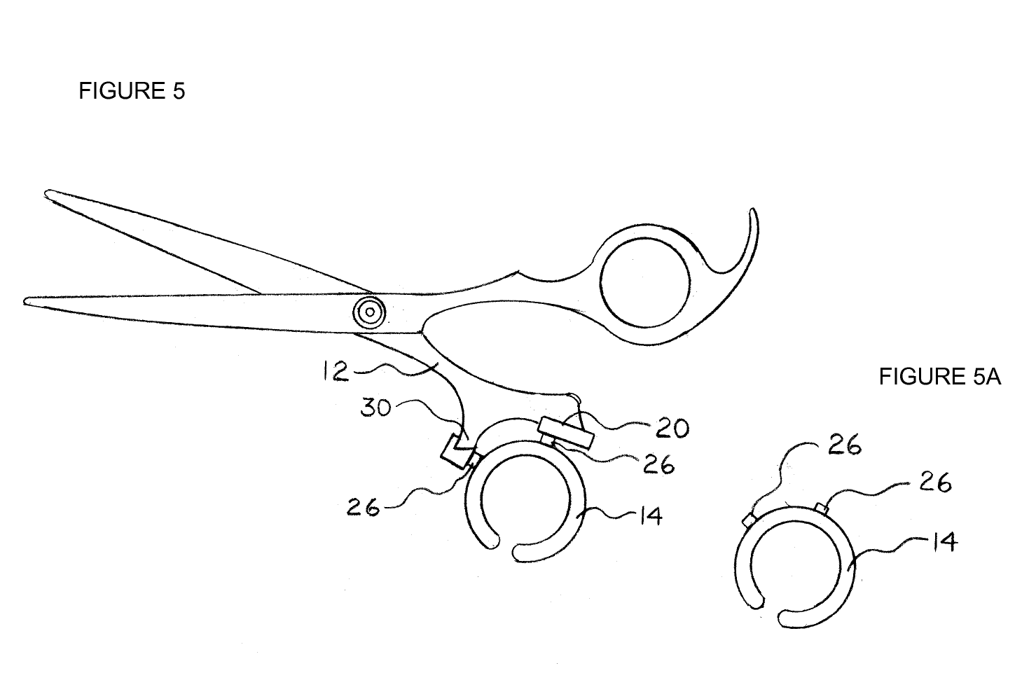

However, it is necessary that materials used to compose thumb ring 14 must include at least one material that is attractive to at least one complimentary attractive material used in flexible fixing mount 20. For example, thumb ring 14 may be made of aluminum with at least one rare earth magnet disposed within its structure such that thumb ring 14 will cooperate with and connect to magnetically attractive material included within the structure of either one or both flexible fixing mount 20 and secure fixing mount 30. FIGS. 5 and 5A show such an example. Thumb ring 14 is formed in a “C” shape and made of aluminum. FIG. 5A shows a view of only the thumb ring structure and best shows a thumb ring magnet 26 fixed to an upper portion of thumb ring 14. A second thumb ring magnet 26 is fixed to a side of thumb ring 14. Thumb ring magnets 26 are disk shaped rare earth magnets. Thumb ring magnets 26 cooperate with and connect to magnetically attractive material incorporated into the structure of flexible fixing mount 20 and secure fixing mount 30 as shown in FIG. 5. The operations and features of this fifth example are similar to those described above pertaining to the first embodiment.

The scissors utilizing a flexible and detachable thumb ring connection may be embodied in other specific forms without departing from the spirit or the essential characteristics thereof. The embodiments are therefore to be considered in all respects as illustrative and not restrictive.

### OPERATION AND SUMMARY OF THE INVENTION

To achieve the foregoing and other objects the scissors utilizing a flexible and detachable thumb ring connection includes a novel means for attaching a thumb ring to a thumb grip handle of a scissors. In our preferred embodiments, the attaching means incorporate rare earth magnets disposed near the terminus of the thumb grip handle to provide magnetic coupling forces. The magnetic coupling forces are so disposed as to attract and couple with the magnetically attractive thumb ring such that the thumb ring may be attached to the handle in either of two operating modes. The thumb ring may be attached in a secure mode wherein it is securely and inflexibly fixed to the handle such that the scissors operate in a fashion similar to conventional scissors. Or, the thumb ring may be attached in a flexible mode wherein the thumb ring is flexibly fixed to the thumb grip handle such that the thumb ring is capable of universal articulate movement with respect to the thumb grip handle.

Regarding the two modes of operation described above, the user may switch between the two modes, while engaged in the act of cutting hair, easily and with out interruption. The user may at any time apply a detaching force, in a certain direction, against the thumb ring to detach it from the thumb grip handle. The detaching force required to overcome the magnetic forces which couple the thumb ring to the handle is greater than forces normally used to operate the scissors. Also, the detaching force is in a direction generally along the longitudinal axis of the thumb grip handle. In directions along the longitudinal axis of thumb handle, substantial force is not usually applied during the normal operation of the scissors.

The thumb ring will remain on the users thumb when it is detached from the scissors. Subsequently the user may bring the thumb ring back into connection with the thumb grip handle in either of two specific orientations. In one orientation the thumb ring will couple in the flexible mode wherein, for example, the magnetic connection is made to a single disk shaped magnet disposed on the thumb grip handle. In this first orientation, the single connection to a flat surface of the magnet allows the thumb ring to universally articulate. In a second and slightly different orientation it will couple in the secure mode of operation wherein, for example, there are two or more magnetic connections securing the thumb ring relatively inflexible with respect to the thumb grip handle.

The detachable thumb ring features and associated desirable characteristics of operation, as described above, also provide a new and unobvious benefit to hair cutters, and others, who commonly use scissors in concert with other hand held tools. There are new benefits to be derived from the capability of the thumb ring of a scissors to easily and continuously detach and reattach, that are heretofore unknown in the prior art of either scissors or haircutting. The features and benefits of the scissors utilizing a flexible and detachable thumb ring connection are described below and are only now made possible and practical by the present improvement.

The ability of the thumb ring to easily detach facilitates a novel new method of cutting hair with a scissors while concurrently using a comb or other tool. The thumb ring is designed to detach from the scissors and remain on the user's thumb where it does not hinder the grasping of a comb or other tool with that same hand. The detachment and reattachment of the thumb ring of the scissors utilizing a flexible and detachable thumb ring connection is quickly and very easily done. In contrast, the complete removal of the user's thumb from the thumb ring of many scissors of the prior art is not as easily done, especially from scissors with rotational thumb rings. Also, the thumb ring or loop remains attached to prior art scissors making those scissors a larger encumbrance to hold in the hand that must also grasp a comb or other tool. The refitting of the thumb back into the thumb ring of most prior art scissors is also not accomplished as quickly or easily as, for example, the magnetically assisted re-coupling of the thumb ring of the scissors utilizing a flexible and detachable thumb ring connection.

Although the description above contains many specificities, these should not be construed as limiting the scope of the invention. For example, the thumb ring attachment can be made with out the use of magnets. Semi-permanent adhesives, bonding materials and the like could also be utilized. Thus, the scope of the invention should be determined by the appended claims and their legal equivalents, rather by the examples given.

We claim:

1. A scissors utilizing a flexible and detachable thumb ring connection comprising:
a moving scissors blade pivotally connected to a stationary scissors blade with a finger grip handle disposed on said stationary scissors blade and a thumb grip handle disposed on said moving scissors blade and
(a) a thumb ring fixed to said thumb grip handle by a fixing means which include a detachable connection for said thumb ring and
(b) wherein said detachable connection is arranged to allow for detachment of said thumb ring from said thumb grip handle to be made without recourse to use of tools or two handed manipulations and
(c) wherein said detachable connection is arranged to allow for reattachment of said thumb ring to said thumb grip handle to be made without recourse to use of tools or two handed manipulations
(d) whereby said thumb ring can be repeatedly detached and reattached from said thumb grip handle even while the scissors are in normal and conventional operative use thereby facilitating the scissors advantageous use together in concert with other hand held tools.

2. The scissors of claim 1 wherein said fixing means includes a rotational connection of said thumb ring to said thumb grip handle whereby rotational motion of said thumb ring relative to said thumb grip handle is facilitated.

3. The scissors of claim 1 wherein said fixing means includes at least one connection which utilizes magnetic force.

4. The scissors of claim 1 wherein said fixing means includes at least one rare earth magnet and said thumb ring includes magnetically attractive material.

5. The scissors of claim 1 wherein said fixing means includes at least one magnet which is arranged to provide an attachment in a flexible coupled position of said thumb ring to said thumb grip handle wherein said thumb ring will articulate in universal rotational movement relative to said thumb grip handle.

6. The scissors of claim 5 wherein said fixing means includes at least one rare earth magnet and said thumb ring includes magnetically attractive material.

7. The scissors of claim 5 wherein said fixing means is arranged to provide alternative attachment in a secure coupled position of said thumb ring to said thumb grip handle wherein said thumb ring will attach substantially secure and unmoving relative to said thumb grip handle.

8. The scissors of claim 7 wherein said fixing means is arranged to allow a switching between said flexible coupled position and said secure coupled position even while the scissors are in normal and conventional operative use.

9. The scissors of claim 8 wherein said fixing means is arranged to allow said switching to be made without recourse to two handed manipulations or to use of tools whereby the scissors may either be operated in said flexible coupled position whereby a variable range of comfortable scissors positioning is facilitated or operated in said secure coupled position whereby operational control and accurate scissors guidance is optimized.

10. A scissors comprising: a moving scissors blade pivotally connected to a stationary scissors blade with a finger grip handle disposed on said stationary blade and a thumb grip handle disposed on said moving blade, the improvement comprising:
a thumb ring disposed on said thumb grip handle with magnetic connection means which are so disposed as to enable said thumb ring to articulate in universal rotational movement relative to said thumb grip handle.

11. The scissors according to claim 10 wherein said connection means include at least one magnet.

12. The scissors according to claim 10 wherein said connection means include at least one rare earth magnet and said thumb ring contains magnetically attractive material.

13. The scissors according to claim 10 wherein said connection means contain detachable connective structure enabling a flexible mode of attachment of said thumb ring to said thumb grip handle wherein said thumb ring can be repeatedly detached and reattached from said thumb grip handle even while the scissors are in normal and conventional operative use thereby facilitating the scissors advantageous use together in concert with other hand held tools.

14. The scissors according to claim 13 wherein said connection means contain connective structure enabling a secure mode of attachment of said thumb ring to said thumb grip handle wherein said thumb ring may alternatively be attached substantially secure and unmoving with respect to said thumb grip handle.

15. The scissors according to claim 14 wherein said connection means is arranged to allow a switching between said flexible mode of attachment and said secure mode of attachment of said thumb ring to said thumb grip handle enabled by said connection means being so arranged that said thumb ring may alternatively be attached substantially secure and unmoving with respect to said thumb grip handle.

16. The scissors according to claim 14 wherein said connection means is arranged to allow a switching between said secure mode of attachment and said flexible mode of attachment of said thumb ring to said thumb grip handle enabled by said connection means being so arranged that said thumb ring may alternatively be attached articulate in universal rotational movement relative to said thumb grip handle.

17. The scissors according to claim 15 wherein said connection means is arranged to allow said switching to be made without recourse to two handed manipulations or to use of tools whereby the scissors may either be operated in said flexible mode of attachment whereby a variable range of comfortable scissors positioning is facilitated or operated in said secure mode of attachment whereby operational control and accurate scissors guidance is optimized.

18. The scissors according to claim 16 wherein said connection means is arranged to allow said switching to be made without recourse to two handed manipulations or to use of tools whereby the scissors may either be operated in said flexible mode of attachment whereby a variable range of comfortable scissors positioning is facilitated or operated in said secure mode of attachment whereby operational control and accurate scissors guidance is optimized.

19. A method of operating a scissors while concurrently operating a second hand held tool comprising the following steps:
(a) a user places their fingers on a finger handle of the scissors utilizing a detachable thumb ring connection and places a thumb in a thumb ring which is detachably connected to a thumb grip handle of the scissors and cuts with the scissors in conventional fashion,
(b) the user detaches said thumb ring from said thumb grip handle of the scissors and said thumb ring remains on the user's thumb,
(c) the user now re-grips the scissors in a more convenient position in the hand, by any technique known in the pertinent art,
(d) the user grasps the second tool even while said thumb ring remains on the thumb,
(e) the user operates the second tool even while the scissors remain held in the same hand,
(f) the user releases the second tool from the hand and transfers it to that other hand that is not holding nor operating the scissors,
(g) the user regains operative use of the scissors by bringing said thumb ring into close contact with said thumb grip handle wherein said thumb ring will immediately reconnect to said thumb grip handle,
(h) the user proceeds to operate the scissors in a conventional fashion.
